(19) United States
(12) Patent Application Publication
(10) Pub. No.: US 2012/0222308 A1
(43) Pub. Date: Sep. 6, 2012

(54) METHOD FOR MANUFACTURING LIQUID EJECTION HEAD

(75) Inventors: Tamaki Sato, Kawasaki-shi (JP); Masafumi Morisue, Tokyo (JP); Hirono Yoneyama, Chigasaki-shi (JP); Takumi Suzuki, Yokohama-shi (JP)

(73) Assignee: CANON KABUSHIKI KAISHA, Tokyo (JP)

(21) Appl. No.: 13/505,574

(22) PCT Filed: Nov. 2, 2010
(86) PCT No.: PCT/JP2010/006474

§ 371 Date: May 2, 2012

(30) Foreign Application Priority Data
Nov. 11, 2009 (JP) 2009-258192

(51) Int. Cl. B41J 2/16

(52) U.S. Cl. 29/890.1

(57) ABSTRACT

A method for manufacturing a liquid ejection head which has an ejection port ejecting a liquid and a flow path communicating with the ejection port, includes a first step of preparing a substrate on which a first layer and a second layer are evenly laminated in this order; a second step of forming a member (A) for forming the ejection port from the second layer; a third step of forming a mold for forming the flow path from the first layer; a fourth step of providing a third layer so as to cover the mold and so as to come into close contact with the member (A); and a fifth step of removing the mold to form the flow path.

### TECHNICAL FIELD

The present invention relates to a method for processing a silicon substrate and a method for manufacturing a substrate for a liquid ejection head.

### BACKGROUND ART

As one representative example of a liquid ejection head ejecting a liquid, there may be mentioned an ink jet recording head applied to an ink jet recording method which performs recording by ejecting ink to a recording medium. In general, a liquid ejection head represented by the ink jet recording head includes flow paths, energy generating portions provided in the respective flow paths, and minute ejection ports for ejecting a liquid by energy generated in the energy generating portion. For manufacturing this liquid ejection head, a lithographic method using photosensitive materials is frequently employed in view of microfabrication and the like.

In the method disclosed in Japanese Patent Laid-Open No. 2006-044237 (Patent Literature 1), a patterned layer of molds for flow paths is formed using a photo-sensitive material on a substrate having ejection energy generating portions, and subsequently, a covering layer formed into a flow path wall forming member is provided on the patterned layer. After openings used as ejection ports are formed in the covering layer on the patterned layer of molds for flow paths and at positions facing energy generating surfaces of the energy generating portions, the patterned layer is removed, so that rooms each functioning as a flow path are formed.

However, when the liquid ejection head is manufactured using the method disclosed in Patent Literature 1, the following may unfavorably arise in some cases.

For example, since being formed along the patterned layer of molds for flow paths, the covering layer is liable to be influenced by the shape of the patterned layer. Hence, the thickness of the covering layer in the vicinity of the central portion of the patterned layer may be different from the thickness of the covering layer in the vicinity of the end portion of the patterned layer, and as a result, the distribution in thickness of the covering layer may be generated. In addition, when solvent coating of a liquid photo-sensitive resin is performed on a silicon wafer to form the covering layer, while a solvent of the photosensitive resin evaporates, the photosensitive resin spreads so as to get over the patterned layer. Hence, the thickness of the covering layer located at a central side of the wafer is unfavorably different from the thickness of the covering layer located along an outer peripheral portion of the wafer.

Since the thickness of the covering layer on the patterned layer determines the length of a liquid path of an ejection port portion, when the variation in thickness of the covering layer occurs, the distance between the ejection port surface and the energy generating surface of the energy generating portion (element) may vary. Since this distance is a factor having a strong influence on the amount of a liquid to be ejected, when the above variation occurs, it becomes difficult to stably eject liquid droplets having uniform liquid volumes. This is a serious problem in the field of an ink jet recording method by the following reasons.

In the field of an ink jet recording method, further improvement in image quality has been increasingly demanded year by year.

Hence, an ejected liquid droplet is required to be minimized, and the liquid ejection head is also increasingly required to satisfy the above requirement.

### Citation List

### Patent Literature

PTL 1: Japanese Patent Laid-Open No. 2006-044237

### SUMMARY OF INVENTION

The present invention provides a method for manufacturing a liquid ejection head with good yield, the liquid ejection head being capable of suppressing variation in liquid volume of ejected liquid droplets and of stably and repeatedly ejecting liquid droplets having uniform liquid volumes.

According to one aspect of the present invention, there is provided a method for manufacturing a liquid ejection head which has ejection ports each ejecting a liquid and flow paths communicating with the ejection ports, comprising:

a first step of preparing a substrate on which a first layer and a second layer are evenly laminated in this order; a second step of forming members (A) for forming the ejection ports from the second layer; a third step of forming molds for forming the flow paths from the first layer; a fourth step of providing a third layer so as to cover the molds and so as to come into close contact with the members (A); and a fifth step of removing the molds to form the flow paths.

According to the present invention, a liquid ejection head which can suppress the variation in liquid volume of ejected liquid droplets and which can stably and repeatedly eject liquid droplets having uniform liquid volumes can be manufactured with good yield.

### BRIEF DESCRIPTION OF DRAWINGS

FIGS. 1A to 1J are schematic cross-sectional views each illustrating a method for manufacturing a liquid ejection head according to a first embodiment of the present invention.

FIGS. 2A to 2G are schematic cross-sectional views each illustrating a method for manufacturing a liquid ejection head according to a third embodiment of the present invention.

FIGS. 3A to 3E are schematic cross-sectional views each illustrating a method for manufacturing a liquid ejection head according to a second embodiment of the present invention.

FIGS. 4A and 4B are schematic cross-sectional views each illustrating another method for manufacturing a liquid ejection head according to the second embodiment of the present invention.

FIG. 5 is a schematic cross-sectional view illustrating a liquid ejection head obtained by the method for manufacturing a liquid ejection head according to the second embodiment of the present invention.

FIGS. 6A and 6B are schematic cross-sectional views illustrating, respectively, another method for manufacturing a liquid ejection head according to the first embodiment of the present invention and a liquid ejection head obtained thereby.

FIG. 7 is a schematic perspective view showing one example of a liquid ejection head obtained by a method for manufacturing a liquid ejection head of the present invention.

FIGS. 8A to 8F are schematic cross-sectional views each illustrating a method for manufacturing a liquid ejection head according to a comparative example.

### DESCRIPTION OF EMBODIMENTS

Hereinafter, the present invention will be described with reference to the drawings.

A liquid ejection head can be mounted on an apparatus such as a printer, a copying machine, a facsimile machine having a communication system, a word processor having a printer unit, and also an industrial recording apparatus integrally combined with various processing devices. The liquid ejection head can also be used, for example, for biochip production, printing of electronic circuits, and spraying of chemicals.

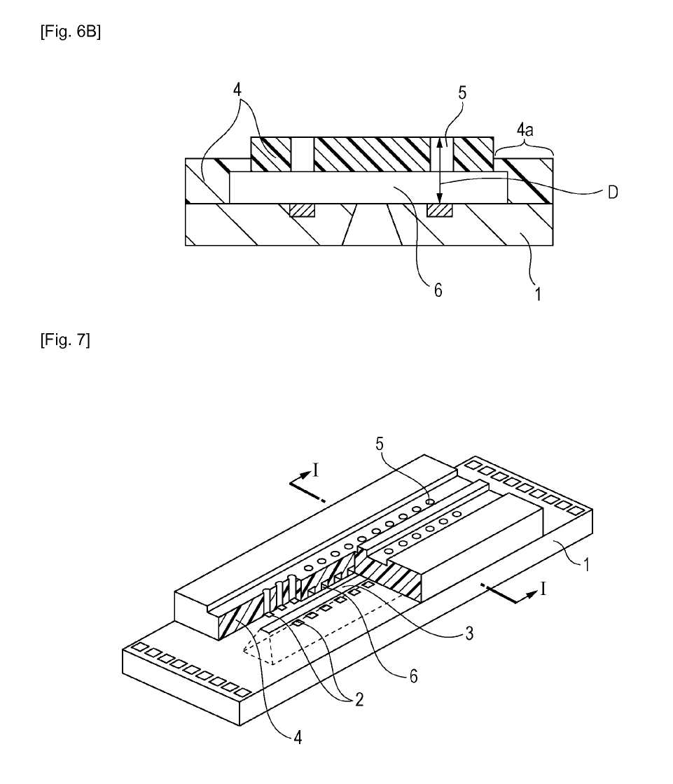

FIG. 7 is a schematic perspective view showing one example of a liquid ejection head of the present invention.

The liquid ejection head of the present invention shown in FIG. 7 has a substrate 1 on which energy generating elements 2, each of which generates energy to eject a liquid such as ink, are formed with a predetermined pitch. A supply port 3 which supplies a liquid is formed in the substrate 1 between two rows of the energy generating elements 2. On the substrate 1, there are formed ejection ports 5 opening above the energy generating elements 2 and liquid flow paths 6 communicating with the respective ejection ports 5 from the ink supply port 3.

A flow-path wall member 4 which forms walls of the flow paths 6 communicating with the respective ejection ports 5 from the supply port 3 is integrally formed with an ejection port member in which the ejection ports 5 are provided.

### First Embodiment

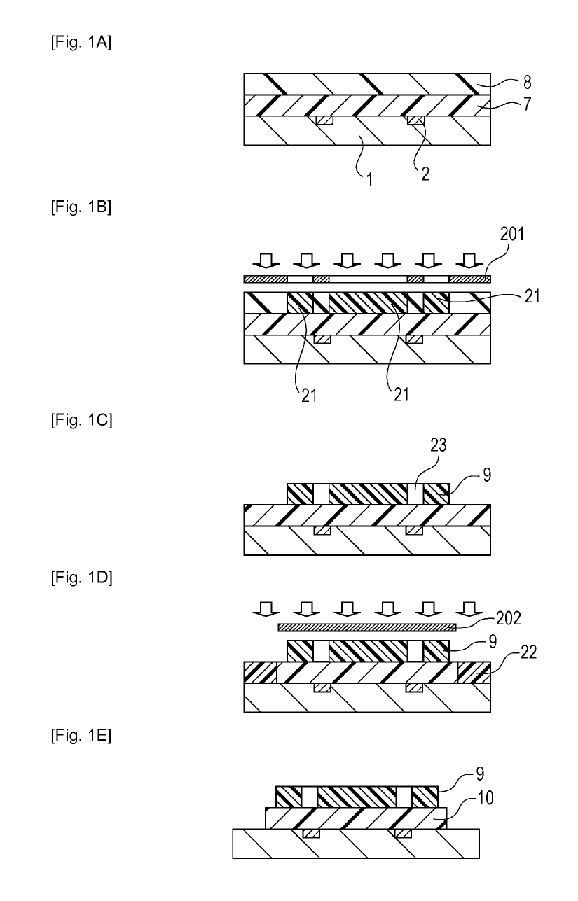

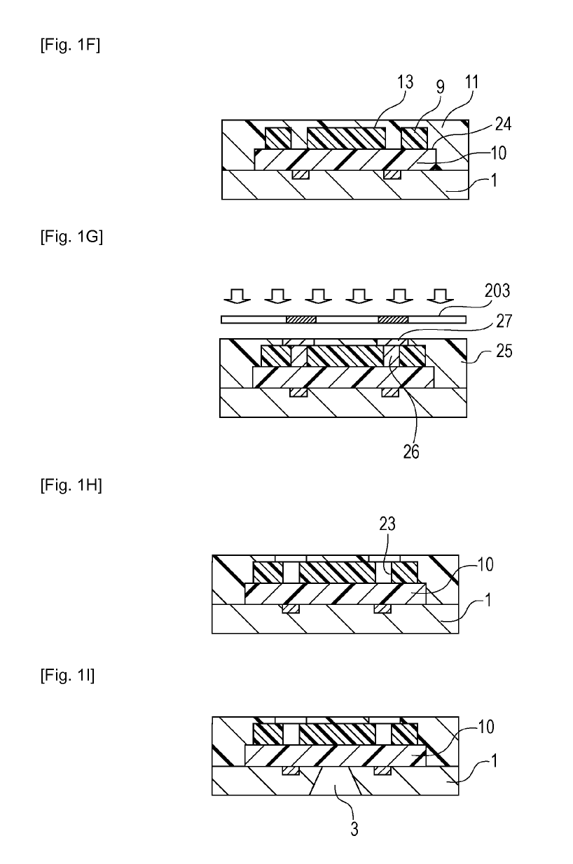

Next, a first embodiment of a method for manufacturing a liquid ejection head of the present invention will be described with reference to FIGS. 1A to 1J. FIG. 7 is a partially cutaway schematic perspective view of a liquid ejection head manufactured in the first embodiment. FIGS. 1A to 1J are schematic cross-sectional views showing the cross-section in each step taken along the line I-I of FIG. 7 perpendicular to the substrate 1.

As shown in FIG. 1A, a first layer 7 and a second layer 8 are evenly laminated to each other in this order on the substrate 1. First, this substrate 1 provided with the above laminate thereon is prepared (first step). As for a preparation method, after the first layer 7 is provided on the substrate 1, the second layer 8 may be laminated on the first layer 7, or a laminate composed of the first layer 7 and the second layer 8, which is prepared beforehand in the form of a film, may be provided on the substrate 1 so that the first layer 7 is located at a substrate 1 side. Since being provided on the first layer 7 before molds for flow paths are formed therein, the second layer 8 is formed evenly on the surface of the substrate 1.

Molds 10 for flow paths are formed from the first layer 7, and ejection port forming members (A)9 are formed from the second layer 8. Since each of the molds 10 on the substrate 1 is finally removed, the first layer 7 can be formed from a material which can be easily removed by using a solvent. By the reason described above, the first layer 7 can be formed from a positive type photosensitive resin. Although through-holes used as the ejection ports are provided in the ejection port forming members (A)9, the through-holes can be formed by a photolithographic method to have minute dimensions with high positional accuracy. In addition, the ejection port forming members (A)9 are each required to have a mechanical strength as a structural member. By the reason described above, the second layer 8 can be formed from a negative type photosensitive resin.

As the positive type photosensitive resin used for the first layer, for example, a poly(methyl isopropenyl ketone) and a copolymer of methacrylic acid and a methacrylate may be mentioned as a suitable resin. The reasons for this are that the above compound can be easily removed by a commonly used solvent and that since the above compound has a simple composition, constituent components thereof have only a small influence on the second layer 8.

As the negative type photosensitive resin used for the second layer 8, for example, a composition containing a resin having an epoxy group, an oxetane group, a vinyl group, or the like and a polymerization initiator corresponding to the above resin may be mentioned as a suitable composition. The reason for this is that since a resin having the above functional group has high polymerization reactivity, the member (A)9 can be obtained to have a high mechanical strength.

The thickness of the first layer 7 and the thickness of the second layer 8 can be appropriately and separately determined. When an ejection port which ejects a minute liquid droplet having a several picoliters and a liquid flow path corresponding to the above ejection port are formed, the thickness of the first layer 7 is preferably set in a range of 3*10⁻⁶ m to 15*10⁻⁶ m, and the thickness of the second layer 8 is preferably set in a range of 3*10⁻⁶ m to 10*10⁻⁶ m.

In this case, a photosensitive liquid repellent material may be provided on a predetermined surface of the second layer 8 for the purpose of imparting a liquid repellent function to the surface in which the ejection ports are provided.

Next, the ejection port forming members (A)9 are formed from the second layer 8 (second step). First, as shown in FIG. 1B, pattern exposure is performed on the second layer 8. This exposure is performed to form the ejection port forming members (A)9. Exposure is performed on the second layer 8 laminated on the first layer 7 having a flat upper surface through a mask 201, and exposed portions 21 are cured. Whenever necessary, curing may be promoted by heating. Subsequently, as shown in FIG. 1C, the second layer 8 is developed, and non-exposed portions of the second layer 8 are removed, so that the ejection port forming members (A)9 are formed. In this case, as shown in FIG. 1C, openings 23, parts of which are used as the ejection ports, are simultaneously formed. The openings 23 can also be formed using an ejection port forming mask after the members (A)9 are formed by removing the non-exposed portions of the second layer 8. Although the openings 23 can be formed at positions facing respective energy generating surfaces of the energy generating elements 2, the positional relationship is not limited to that described above.

Since the first step and the second step are performed in this order, when the surface of the first layer is flat before being machined into the molds for flow paths, the members (A)9 can be obtained from the second layer 8 to have substantially no variation in thickness. As shown in FIG. 1C, in view of simplification of the process, it is suitable that the openings 23 be simultaneously formed when the members (A)9 are formed. On the other hand, after the members (A)9 in which the openings 23 are not formed in the second step are obtained, the openings 23 partly used as the ejection ports can be formed in the members (A)9 by a dry etching method or the like after the third step, which will be described later, in which the molds for flow paths are obtained and before the fourth step in which a third layer is formed. Even in the case described above, since the members (A)9 are formed evenly in the second step, and the evenness thereof is maintained after the third step is performed, the lengths (liquid paths) (in the thickness direction of the member (A)9) of the obtained openings 23 are uniform within the substrate.

In addition, when a liquid repellent material is applied on the surface of the second layer 8, the upper surface of each of the members (A)9 (surface of each member (A)9 opposite to the substrate 1 side) has liquid repellence, and it is convenient since liquids, such as ink, do not adhere to the upper surface of the member (A)9. When an ink including a pigment or a dye is assumed as an ejection liquid, it is believed that liquid repellence at a water advance contact angle of approximately 80 degrees or more is sufficient. A water advance contact angle of approximately 90 degrees or more is more preferable since the adhesion of the liquid to the member (A)9 can be further suppressed.

Subsequently, the mold 10 which has the shape of the flow path is formed from the first layer 7 (third step). As shown in FIG. 1D, in order to form the mold for forming the flow path, exposure is performed on the first layer 7 through a mask 202. The molecular weight of a resin in portions 22 processed by the exposure is decreased, and hence the exposed resin is likely to be dissolved in a developing solution. In this embodiment, exposure is performed on portions (exposed portions 22) of the first layer 7 located outside the members (A)9. Subsequently, as shown in FIG. 1E, development is performed on the first layer 7 using a suitable developing solution to remove the exposed portions 22, so that the mold 10 is formed. At least two molds 10 can be obtained from the first layer 7.

Subsequently, as shown in FIG. 1F, a third layer 11 in close contact with the molds 10 and the members (A)9 is provided to have a height (thickness) larger than that of an upper surface 24 of the mold 10 (fourth step). The third layer 11 is formed to have a thickness larger than the thickness of the mold 10 from the upper surface of the substrate 1, to cover the molds 10, and to come into close contact with the members (A)9.

By the reason described above, when the first layer 7 has a thickness of 3*10⁻⁶ m to 15*10⁻⁶ m, and the second layer 8 has a thickness of 3*10⁻⁶ m to 10*10⁻⁶ m, the third layer 11 is formed to have a thickness of more than 3*10⁻⁶ m from the energy generating surface. In addition to that described above, in consideration of the intensity of stress generated inside the third layer 11, the thickness of the third layer 11 is preferably set to 40*10⁻⁶ m or less.

As for the thickness of the third layer 11, the upper surface position thereof may be higher (larger) than, may be equivalent to, or may be lower (smaller) than the position of an upper surface 13 of the member (A)9. For example, as shown in FIG. 6A, the thickness of the third layer 11 may be formed so as to be small as compared to the upper surface 13 of the member (A)9. In the case shown in FIG. 6A, the third layer 11 is partially filled in the openings 23 used as the ejection ports. The third layer 11 can be formed of a negative type photosensitive resin having the same composition as that of the second layer 8, and suitably, a compound contained in the third layer 11 is the same as that contained in the second layer 8. However, the composition ratio is not necessarily the same.

Next, as shown in FIG. 1G, exposure is performed on the third layer 11 through a mask 203, and exposed portions 25 of the third layer 11 are cured. Since a portion 26 located in the opening 23 used as the ejection port and an upper portion 27 located on the portion 26, which are parts of the third layer 11, must be removed, the portion 26 and the upper portion 27 are shaded by the mask 203.

Subsequently, as shown in FIG. 11I, portions onto which the exposure is not performed are removed, for example, by a liquid development method. When the removal is performed by dissolution, a suitable solvent, such as xylene, may be used according to the composition of the negative type photosensitive resin. The non-exposed portions of the third layer 11, that is, the portion inside the opening 23 used as the ejection port and the portion thereon, are removed.

Next, as shown in FIG. 1I, the supply port 3 is formed in the substrate 1 by dry etching or the like. Accordingly, the mold 10 communicates with the outside.

Subsequently, as shown in FIG. 1J, for example, the mold 10 for forming the flow path is dissolved by a suitable solvent, and the liquid flow path 6 is formed so as to communicate with the ejection ports 5 (fifth step). The flow-path wall member 4 has a wall surface 12 adjacent to the surface in which the ejection ports 5 are formed. The distance between the wall surface 12 and the ejection port 5 is set so that an ejection liquid can form a meniscus in the ejection port 5, that is, at a substrate side apart from an opening surface 14. For example, when the diameter of the ejection port is 15*10⁻⁶ m, the distance from the wall surface 12 to the edge of the ejection port 5 is preferably 80*10⁻⁶ m or more. Since the evenness of the members (A)9 is not degraded by the subsequent steps performed after the formation of the members (A)9, the members (A)9 and the molds 10 are evenly formed, and hence, within the substrate, a distance D from the energy generating surface of the substrate 1 to the ejection port 5 becomes uniform. Hence, the amounts of liquid ejected from a plurality of ejection ports can be made constant.

Subsequently, a liquid repellent function may be imparted to the opening surface 14 of the ejection port 5.

### Second Embodiment

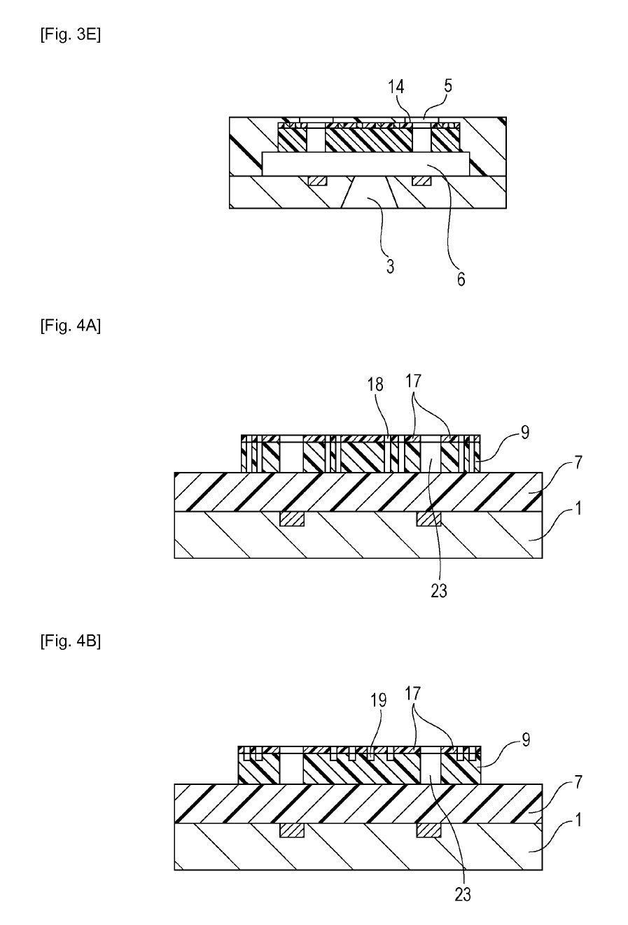

A second embodiment of the present invention will be described with reference to FIGS. 3A to 3E, 4A, 4B, and 5. In this embodiment, a liquid repellent treatment is performed on the surface of the ejection port.

FIGS. 3A to 3E are cross-sectional views showing the cross-section in each step as in the case shown in FIGS. 1A to 1J, and FIGS. 4A, 4B, and 5 are cross-sectional views each illustrating the state in the manufacturing step. The position of the cutting plane is the same as that of FIGS. 1A to 1J.

Steps from the start to the step (first step) shown in FIG. 1A are performed in a manner similar to that in the first embodiment. Subsequently, the following is performed in a step (second step) of forming the members (A)9.

As shown in FIG. 3A, a liquid repellent material 15 for imparting liquid repellence is provided to the upper surface of the second layer 8. The liquid repellent material 15 may be allowed to partially or entirely permeate into the second layer 8. When a liquid to be ejected is an aqueous or an oily ink, sufficient repellence may be obtained by a liquid repellent material having a thickness of 2*10⁻⁶ m in a direction perpendicular to the substrate 1 to which liquid repellence is imparted. As in the case of the first layer 7 and the second layer 8, the liquid repellent material 15 is evenly laminated on the substrate. For example, a photosensitive fluorine-containing epoxy resin film or a composition containing a condensate of a fluorine-containing silane and a silane containing a polymerization group may be used for the liquid repellent material 15. When the above compound is used for the liquid repellent material 15, the liquid repellent material 15 and the second layer 8 can be collectively patterned by photolithography.

Subsequently, as shown in FIG. 3B, exposure for forming the members (A)9 is performed on the second layer 8 and the liquid repellent material 15 through a mask 16. By adjusting the shape of the mask, the exposure is performed so that parts of the liquid repellent material 15 are cured, and the other parts thereof are not cured. In particular, a shade portion 16a is provided in an aperture 50 of the mask 16 so that a portion of the second layer 8 corresponding to the aperture 50 is exposed and a portion of the liquid repellent material 15 corresponding to the shade portion 16a is not exposed. The width of the shade portion 16a is determined in consideration of the resolutions of the second layer 8 and the liquid repellent material 15. Next, the exposed portions are cured and are then developed, so that non-exposed portions of the second layer 8 and the liquid repellent material 15 are removed. Accordingly, as shown in FIG. 3C, a liquid repellant portion 17 having liquid repellence is provided on the upper surface of the member (A)9 around the opening 23 which is used as the ejection port. In addition, when the liquid repellant material provided on a region other than that around the opening 23 is removed, liquid repellence is not imparted to the above region. In addition, by appropriately designing the shape of the mask 16, through-holes 18 may be provided in the member (A)9 as shown in FIG. 4A. By the structure described above, the third layer 11 provided on the upper surface of the member (A)9 is partially filled in the hole 18, and the inner wall of the hole 18 and the third layer 11 are brought into contact with each other. As a result, the bonding strength between the member (A)9 and the third layer 11 can be increased. In addition, by appropriately designing the shape of the mask 16, grooves 19 are formed in the member (A)9 as shown in FIG. 4B, and the inner wall of the groove 19 and the third layer 11 can be brought into contact with each other.

Next, the mold 10 is formed in a manner similar to that of the method described with reference to FIG. 1E (third step), and subsequently, as shown in FIG. 3D, the third layer 11 is formed on the upper surface of the member (A)9 (fourth step). Although the third layer 11 may be repelled on the liquid repellant portion 17 of the member (A)9, the third layer 11 is not repelled on the upper surface of the member (A)9 on which the liquid repel portion 17 is not provided and is brought into close contact with the upper surface of the member (A)9. In addition, since liquid repellence is not imparted to the side surfaces of the member (A)9, the third layer is brought into close contact therewith. Next, after the supply port 3 is formed in the substrate 1, the mold 10 is removed to form the flow path 6 (fifth step), and as shown in FIG. 3E, the liquid ejection head is obtained.

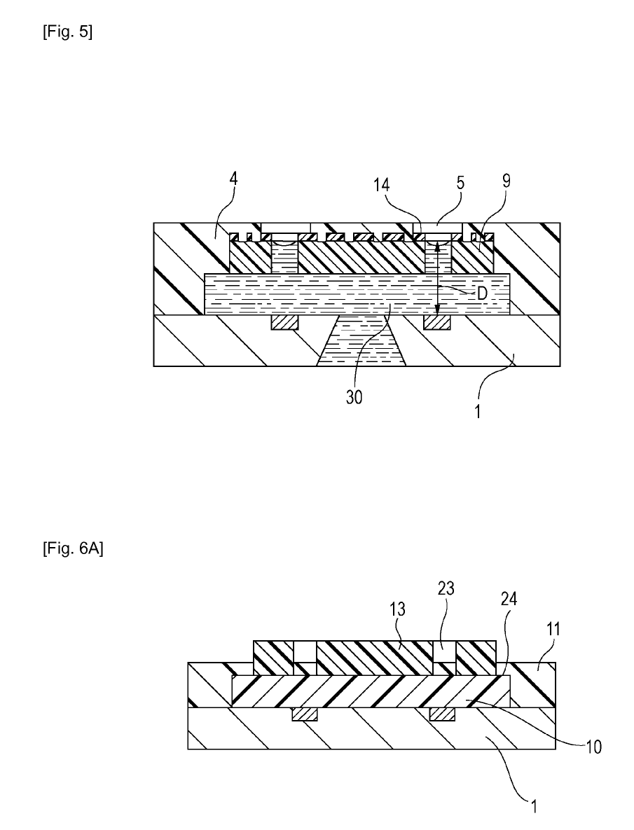

Since liquid repellence is imparted to the opening surface 14 at which the ejection port 5 of the member (A)9 is open, an ejection liquid 30 filled in the flow path does not stay on the opening surface 14 (see FIG. 5) but can reliably form a meniscus at a position approximately equivalent to that of the ejection port 5. In addition, since liquid repellence is imparted to the opening surface 14, even when an ejected liquid partially floats in the form of mist and adheres on the opening surface 14, the mist is not fixed to the opening surface 14 and can be easily removed, for example, by suction of a suction mechanism equipped in an ejection apparatus.

### Third Embodiment

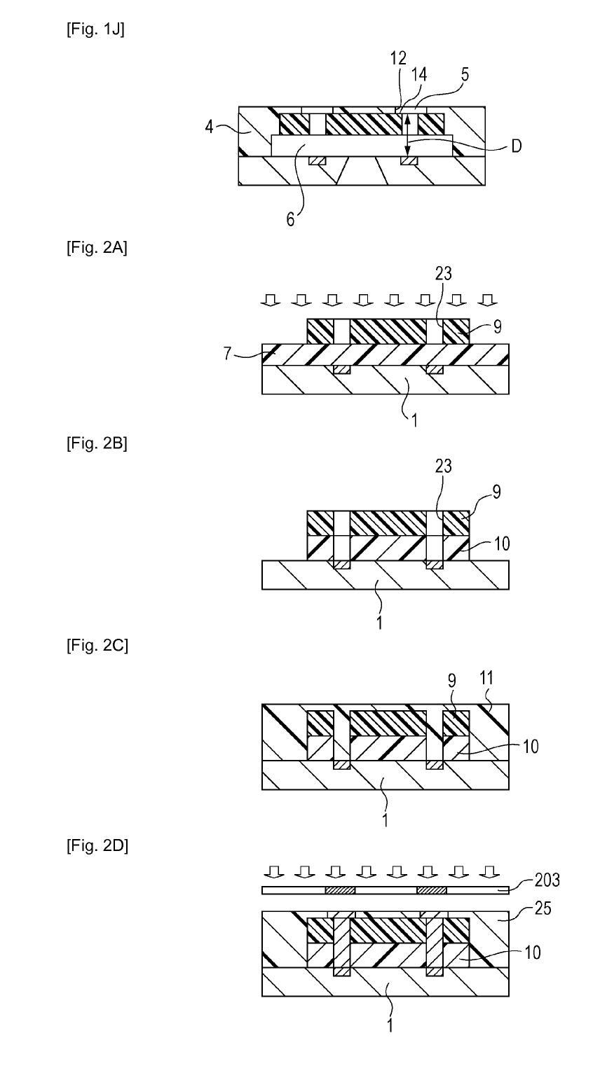

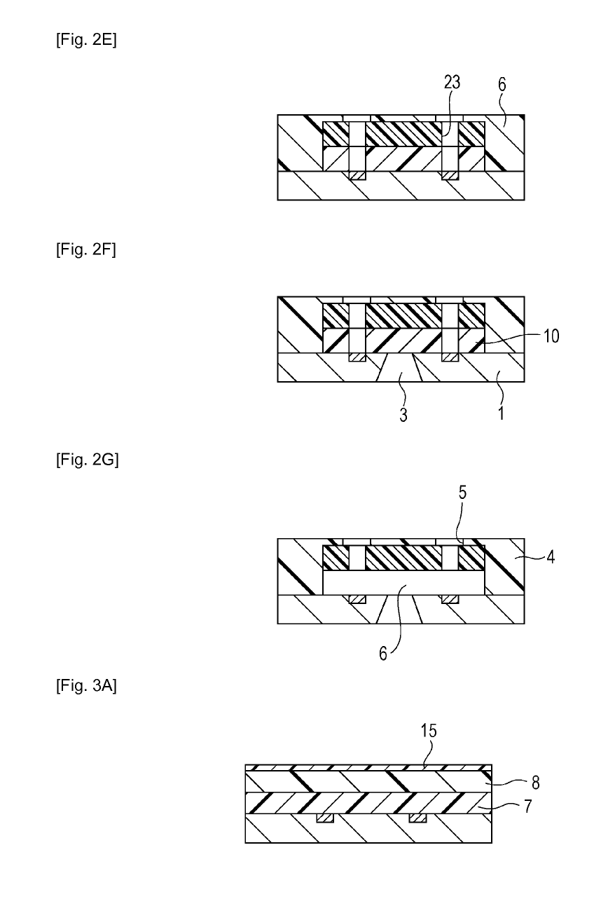

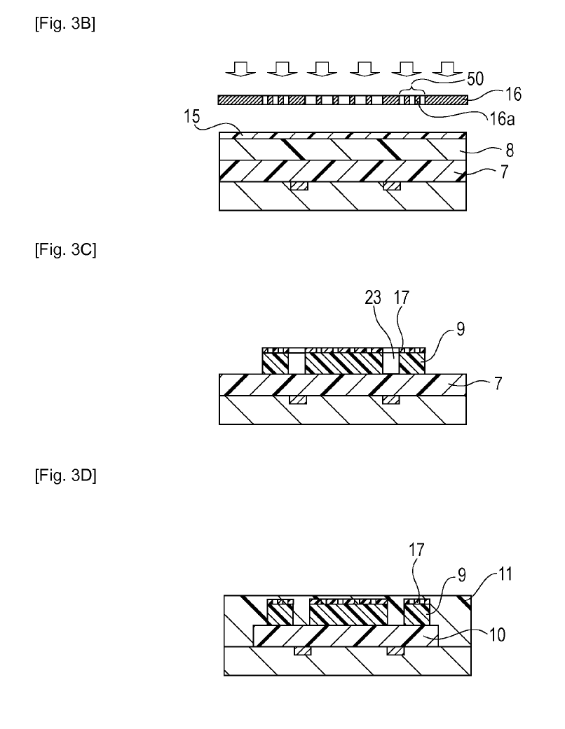

A third embodiment of the present invention will be described with reference to FIGS. 2A to 2G. FIGS. 2A to 2G are cross-sectional views showing the cross-section in each step as in the case shown in FIGS. 1A to 1J, and the position of the cutting plane is the same as that of FIGS. 1A to 1J.

First, the steps shown in FIGS. 1A to 1E described in the first embodiment are performed.

Subsequently, in the step (third step) of forming the molds for flow paths, as shown in FIG. 2A, the first layer 7 of a positive type photosensitive resin is exposed using the members (A)9 as a shade mask. When each of the members (A)9 is formed from a cured material of a negative type photosensitive resin, the member (A)9 can absorb light having a wavelength in a range of 200 nm to 300 nm. On the other hand, the sensitive wavelength of many positive type photosensitive resins is 220 nm to 300 nm; hence, the first layer 7 is exposed by light having a wavelength of 220 nm to 300 nm by using the members (A)9 as a shade mask, the resin in the exposed first layer 7 can be decomposed.

When the exposed portions of the first layer 7 are removed by development, as shown in FIG. 2B, the molds 10 for flow paths can be obtained. Since the shape of the mold 10 for the flow path is formed in accordance with the shape of the member (A)9 in a direction parallel to the surface of the substrate 1, the outline of the member (A)9 must be formed beforehand so as to correspond to the shape of the flow path.

Since the member (A)9 which is in contact with the first layer 7 is used as a shade mask, the alignment accuracy therebetween can be improved. In addition, the first layer is suppressed from being exposed by light diffracted by the shade mask.

Subsequently, the third layer 11 is provided so that the thickness thereof is higher than the upper surface of the mold 10 (fourth step). Next, as shown in FIG. 2D, exposure is performed on the third layer 11 through the mask 203, and the exposed portions 25 of the third layer 11 are cured. Next, as shown in FIG. 2E, non-exposed portions are removed, and the openings 23 are formed. Subsequently, as shown in FIG. 2F, the supply port 3 is formed in the substrate 1. Next, the mold 10 is removed, and the flow path 6 and the ejection ports 5 are formed, so that the liquid ejection head in the state shown in FIG. 2G is obtained (fifth step).

Hereinafter, the present invention will be described in more detail with reference to Examples.

### Example 1

With reference to FIGS. 1A to 1J, Example 1 will be described assuming that the substrate 1 is a part of a substrate before it is cut into small pieces.

First, the substrate 1 (6-inch wafer) provided with the first layer 7 and the second layer 8 was prepared (FIG. 1A). After ODUR-1010 (manufactured by Tokyo Ohka Kogyo Co., Ltd.), which was a positive type photosensitive resin, was applied by a spin coating method, drying was performed at 120 degrees centigrade, so that the first layer 7 was formed. The average thickness of the first layer 7 after its formation was 7*10⁻⁶ m, and the standard deviation of the thickness of the first layer 7 within the substrate 1 (6-inch wafer) was 0.1*10⁻⁶ m or less (350 positions in the 6-inch wafer were measured).

Next, a composition shown in Table 1 was applied on the first layer 7 using a spin coating and was dried at 90 degrees centigrade for 3 minutes, so that the second layer 8 was formed. The average thickness of the second layer 8 was 5*10⁻⁶ m, and the standard deviation of the thickness thereof within the substrate (6-inch wafer) was 0.2*10⁻⁶ m (350 positions in the 6-inch wafer were measured).

TABLE 1

| Composition | Parts by weight |
|---|---|
| EHPE-3150 (by Daicel Chemical Industries, | 100 |
| Ltd.) | |
| A-187 (by Nippon Unicar Co., Ltd.) | 5 |
| Copper triflate | 0.5 |
| SP-170 (Asahi Denka Kogyo K.K.) | 0.5 |
| Methyl isobutyl ketone | 100 |
| xylene | 100 |

Next, the second layer 8 was exposed using a mask aligner MPA-600 Super (product name) manufactured by CANON KABUSHIKI KAISHA (FIG. 1B).

Subsequently, postbake and development were performed on the second layer 8, so that the members (A)9 were formed. In addition, the exposure dose was 1 J/cm², a mixed liquid of methyl isobutyl ketone/xylene at a ratio of 2/3 was used as a developing solution, and xylene was used as a rinse agent after development.

Next, the first layer 7 was irradiated at 10 J/cm² with deep-UV light (wavelength of 220 nm to 400 nm) using a mask aligner UX-3000SC (product name) manufactured by Ushio, Inc. (FIG. 1D).

Subsequently, after development of the first layer 7 was performed using methyl isobutyl ketone, the first layer 7 was rinsed with isopropyl alcohol, and the exposed portions of the first layer 7 were removed, so that the molds 10 for flow paths were formed (FIG. 1E).

Next, the composition shown in Table 1 was applied on the members (A)9 and the molds 10, so that the third layer 11 was formed (FIG. 1F). The third layer 11 was formed so that the thickness from the surface of the substrate 1 to the upper surface of a part of the third layer located above the member (A)9 was 18*10⁻⁶ m.

Subsequently, after exposure was performed on the third layer 11 (exposure dose=1 J/cm²) by MPA-600 Super (product name: manufactured by CANON KABUSHIKI KAISHA) (FIG. 1G), postbake, development, and rinse were performed, so that the openings 23 each having a diameter of 12*10⁻⁶ m were formed (FIG. 1H). A mixed liquid of methyl isobutyl ketone/xylene at a ratio of 2/3 was used as a developing solution, and xylene was used for the rinse after the development.

By using a tetramethylammonium hydroxide aqueous solution at 80 degrees centigrade as an etching solution, anisotropic etching was performed on the substrate 1 of silicon, so that the supply port 3 was formed (FIG. 1I).

Then, the molds 10 on the substrate 1 were dissolved by methyl lactate and were removed, so that the ejection ports 5 each having a diameter of 12*10⁻⁶ m were formed (FIG. 1J).

Within the substrate (6-inch wafer), the average distance D was 12*10⁻⁶ m, and the standard deviation thereof was 0.25*10⁻⁶ m. Incidentally, 350 ejection ports in the wafer were evenly selected from the center to the end of the wafer, and the distance D was obtained from each ejection port by measurement.

Finally, the 6-inch wafer was cut by a dicing saw, and one liquid ejection head was obtained.

### Example 2

Example 2 will be described with reference to FIGS. 6A and 6B. FIGS. 6A and 6B are cross-sectional views each illustrating the state in the step of manufacturing a liquid ejection head according to this example of the present invention. The position of the cutting plane is the same as that of FIGS. 1A to 1J.

Different points of Example 2 from Example 1 were as follows. The thickness of the second layer 8 from the upper surface of the first layer 7 was set to 10*10⁻⁶ m, and the third layer 11 was formed so that the height of the upper surface of a portion thereof provided on the first layer 7 was set to 5*10⁻⁶ m from the upper surface of the first layer 7. As described above, the third layer 11 was provided so that the upper surface thereof was located lower than the upper surface of the member (A)9. The others points of this example were performed in a manner similar to that in Example 1.

FIG. 6B shows the liquid ejection head formed as described above. The ejection port 5 was provided at a position higher than the upper surface of an outer wall portion 4a of the flow-path wall member 4 based on the substrate.

Within the substrate (6-inch wafer), the average distance D was 17*10⁻⁶ m, and the standard deviation of the distance D was 0.25*10⁻⁶ m. In addition, as in Example 1, 350 ejection ports in the wafer (6-inch wafer) were evenly selected from the center to the end of the wafer, and the distance D of each ejection port was measured.

### Comparative Example 1

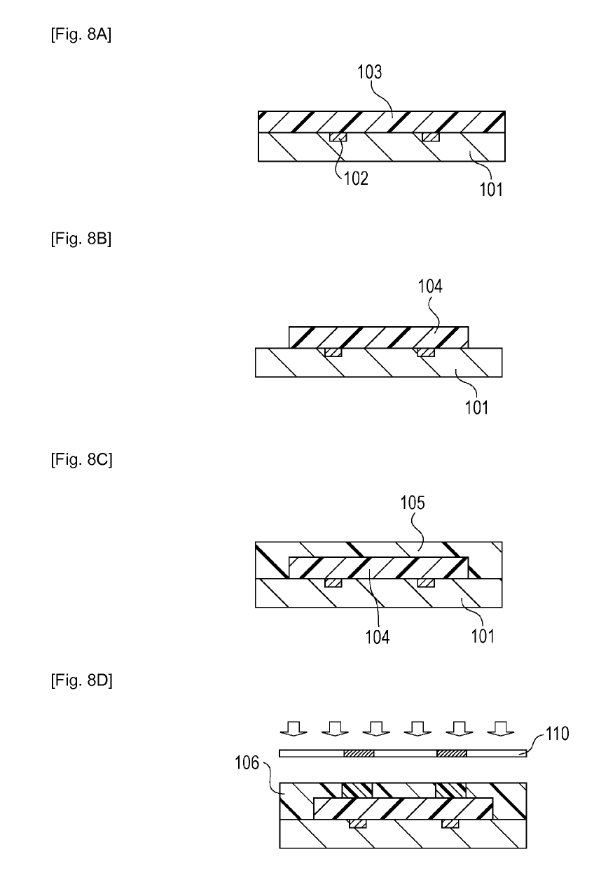

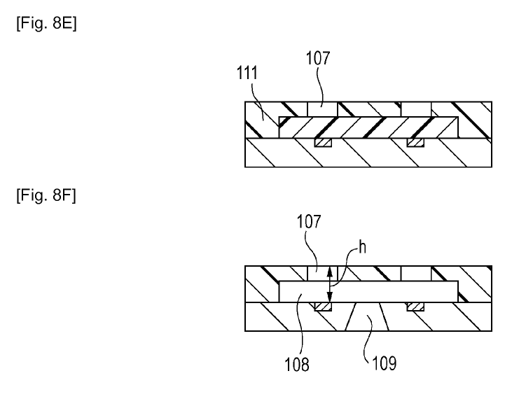

A method for forming a liquid ejection head according to a comparative example will be described with reference to FIGS. 8A to 8F.

FIGS. 8A to 8F are cross-sectional views of steps of forming a liquid ejection head according to the comparative example.

After ODUR-1010 (trade name, manufactured by Tokyo Ohka Kogyo Co., Ltd.) was applied on a silicon substrate 101 (6-inch wafer) provided with energy generating elements 102, drying was performed, so that a layer 103 of a positive type photo-sensitive resin having a thickness of 7*10⁻⁶ m was formed on the substrate 101 (FIG. 8A).

Subsequently, exposure and following development were performed on the layer 103 of a positive type photosensitive resin, so that a mold 104 for a flow path was formed (FIG. 8B).

Next, the composition shown in Table 1 of Example 1 was applied on the mold 104 using a spin coating method, followed by performing drying at 90 degrees centigrade for 3 minutes, so that a covering layer 105 was formed. The covering layer 105 was formed so that a portion thereof provided on the upper surface of the mold 104 had a thickness of 7*10⁻⁶ m (FIG. 8C).

Subsequently, exposure was performed on the covering layer 105 using a mask 110, and an exposed portion 106 was cured (FIG. 8D).

Non-exposed portions of the covering layer 105 were removed by development, so that a member 111 forming walls of the flow paths and ejection ports 107 each having a diameter of 12*10⁻⁶ m were formed (FIG. 8E).

Next, after a supply port 109 was formed in the substrate 101, the mold 104 was removed, so that a flow path 108 was formed (FIG. 8F).

Next, the 6-inch wafer was cut by a dicing saw, and one liquid ejection head unit was separated.

In the liquid ejection head thus obtained, the average value of a distance h from the energy generating surface of the energy generating element 102 of the substrate 101 to the ejection port 107 was 12*10⁻⁶ m. In addition, the standard deviation of the distance h was 0.6*10⁻⁶ m. Incidentally, 350 ejection ports in the wafer were evenly selected from the center to the end of the wafer, and the distance h was obtained from each ejection port by measurement.

It is found that the standard deviation of the distance D of the liquid ejection head according to each of Examples 1 and 2 is significantly different from the standard deviation of the distance h of the liquid ejection head according to Comparative Example 1.

The reason the standard deviation of the distance D was as small as 0.25*10⁻⁶ m is believed that the members (A)9 having a significantly small variation in thickness can be obtained from the second layer 8 which is evenly formed.

On the other hand, one reason the standard deviation of the distance h was as large as 0.6*10⁻⁶ m is believed that the height of the upper surface of the covering layer 105 under which the mold 104 is provided is different from that under which the mold 104 is not provided. In addition, as another reason the standard deviation of the distance h was large in Comparative Example 1 is believed as follows. Since no mold 104 is provided at a position outside the mold 104 which is provided at an outermost peripheral portion of a 6-inch wafer, the height of the upper surface of the covering layer 105 at the peripheral portion of the wafer is formed relatively lower than that at the central portion thereof.

Test recording was performed using the liquid ejection heads of Examples 1 and 2 and Comparative Example 1. The recording was performed using a plurality of liquid ejection heads cut out from the same 6-inch wafer. In addition, a liquid ink containing pure water/diethylene glycol/isopropyl alcohol/lithium acetate/black dye food black 2 at a ratio of 79.4/15/3/0.1/2.5 was used, and the recording was performed at an ejection volume Vd of 1 picoliter and an ejection frequency f of 15 kHz.

When the image obtained by recording was observed, it was found that a very high quality recording image was obtained when recording was performed using the liquid ejection heads of Examples 1 and 2. In addition, the images formed by a plurality of liquid ejection heads obtained from the same 6-inch wafer were equally high quality. On the other hand, when the recording was performed using the liquid ejection head of Comparative Example 1, the recorded image was non-uniform as compared to that of each of Examples 1 and 2. In addition, when the recorded images obtained by using a plurality of liquid ejection heads formed from the same 6-inch wafer were compared to each other, the degree of non-uniformity was slightly different from each other. The reason for this is believed that since the standard deviation of the distance D described above is smaller than that of the distance h, the variation in volume of ink ejected from the liquid ejection head of each of Examples 1 and 2 is smaller than the variation in volume of ink ejected from the liquid ejection head of Comparative Example 1.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-258192, filed Nov. 11, 2009, which is hereby incorporated by reference herein in its entirety.

1. A method for manufacturing a liquid ejection head which includes an ejection port ejecting a liquid and a flow path communicating with the ejection port, the method comprising:
a first step of preparing a substrate on which a first layer and a second layer are evenly laminated in this order;
a second step of forming a member (A) for forming the ejection port from the second layer;
a third step of forming a mold for forming the flow path from the first layer;
a fourth step of providing a third layer so as to cover the mold and so as to come into close contact with the member (A); and
a fifth step of removing the mold to form the flow path.

2. The method for manufacturing a liquid ejection head according to claim 1, wherein the first step includes a substep of providing the first layer containing a non-exposed positive type photosensitive resin on the substrate and a substep of providing the second layer on the first layer, and after the second step, exposure is performed on the first layer to form the mold.

3. The method for manufacturing a liquid ejection head according to claim 1, wherein in the second step, an opening used as the ejection port is formed in the member (A).

4. The method for manufacturing a liquid ejection head according to claim 1, wherein the third layer is provided to have a height equivalent to or lower than that of an upper surface of the member (A).

5. The method for manufacturing a liquid ejection head according to claim 3, wherein before the fourth step is performed, liquid repellence is imparted to a portion in the periphery of the opening of the member (A).

6. The method for manufacturing a liquid ejection head according to claim 3, wherein before the fourth step is performed, a liquid repellant portion and a non-liquid repellant portion are provided on a surface of the member (A) opposite to the substrate.

7. The method for manufacturing a liquid ejection head according to claim 6, wherein the liquid repellant portion is a portion in the periphery of the opening of the member (A), and the member (A) is in contact with the third layer at the non-liquid repellent portion.

8. The method for manufacturing a liquid ejection head according to claim 6, wherein in the second step, a material imparting liquid repellence is provided on the second layer, the liquid repellence is imparted to a portion in the periphery of the opening by the material, and the material provided on a portion other than that in the periphery of the opening is removed.

9. The method for manufacturing a liquid ejection head according to claim 8, wherein in the second step, when the material is removed, a portion of the second layer located under the material which is removed is simultaneously removed.

10. The method for manufacturing a liquid ejection head according to claim 1, wherein the second layer includes a negative type photo-sensitive resin.

11. The method for manufacturing a liquid ejection head according to claim 1, wherein the second layer and the third layer include negative type photosensitive resins having the same composition.

12. The method for manufacturing a liquid ejection head according to claim 1, wherein in the second step of forming a member (A), the shape of the member (A) is formed to correspond to the shape of the flow path, and by using the member (A) as a mask, the mold is formed by removing a portion of the first layer on which the member (A) is not laminated.

13. The method for manufacturing a liquid ejection head according to claim 1, wherein the first layer includes a positive type photosensitive resin, and after the first layer is exposed using the member (A) as a mask, the mold is formed by removing the exposed portion.

14. The method for manufacturing a liquid ejection head according to claim 3, wherein after the fifth step is performed, liquid repellence is imparted to a portion in the periphery of the opening of the member (A).
